(19) United States
(12) Patent Application Publication
(10) Pub. No.: US 2008/0029675 A1
(43) Pub. Date: Feb. 7, 2008

(54) VEHICLE DESK

(76) Inventor: Waldemar S. Thorwaldson, Walnut, CA (US)

Correspondence Address: LAW OFFICES OF LARRY K. ROBERTS, INC., 2 Park Plaza, Suite 300, Irvine, CA, 92614, US

(21) Appl. No.: 11/462,233

(22) Filed: Aug. 3, 2006

(51) Int. Cl. B42F 13/00

(52) U.S. Cl. 248/339

(57) ABSTRACT

A portable desk for use in a vehicle having a steering wheel. An exemplary embodiment of the desk includes a generally planar working surface portion and a retainer portion adapted for engaging the steering wheel to hold the desk in a working position on the steering wheel. The exemplary embodiment of a portable desk is adapted for ready engagement with the steering wheel to support the desk in the working position and ready disengagement from the steering wheel for storage or vehicle operation.

### BACKGROUND

Many people enjoy occupations or avocations in which they frequently operate from a vehicle, and in which papers or documents are opened or spread out for inspection or preparation. By way of example, and without limitation, contractors who travel to a customer's place of business or residence may need to write up work orders, receipts or invoices. It is inconvenient to spread out documents on the hood of the vehicle, and clipboards may be inconvenient or uncomfortable to use.

### BRIEF DESCRIPTION OF THE DRAWINGS

FIG. 1 is an isometric view of an exemplary embodiment of a portable vehicle desk in a working position on a vehicle steering wheel.

FIG. 2 is a view similar to FIG. 1, but illustrating a work piece on the vehicle desk.

FIG. 3 is a front isometric view of an exemplary embodiment of a portable vehicle desk.

FIG. 4 is a rear isometric view of an exemplary embodiment of a portable vehicle desk.

FIG. 5 is a front view of an exemplary embodiment of a vehicle desk.

FIG. 6 is a side view of an exemplary embodiment of a vehicle desk.

FIG. 7 is a rear isometric view of an alternate embodiment of a vehicle desk.

FIG. 8 is a rear view of the vehicle desk of FIG. 7, installed on a vehicle steering wheel.

### DETAILED DESCRIPTION

In the following detailed description and in the several figures of the drawing, like elements are identified with like reference numerals. The figures may not be to scale, and relative feature sizes may be exaggerated for illustrative purposes.

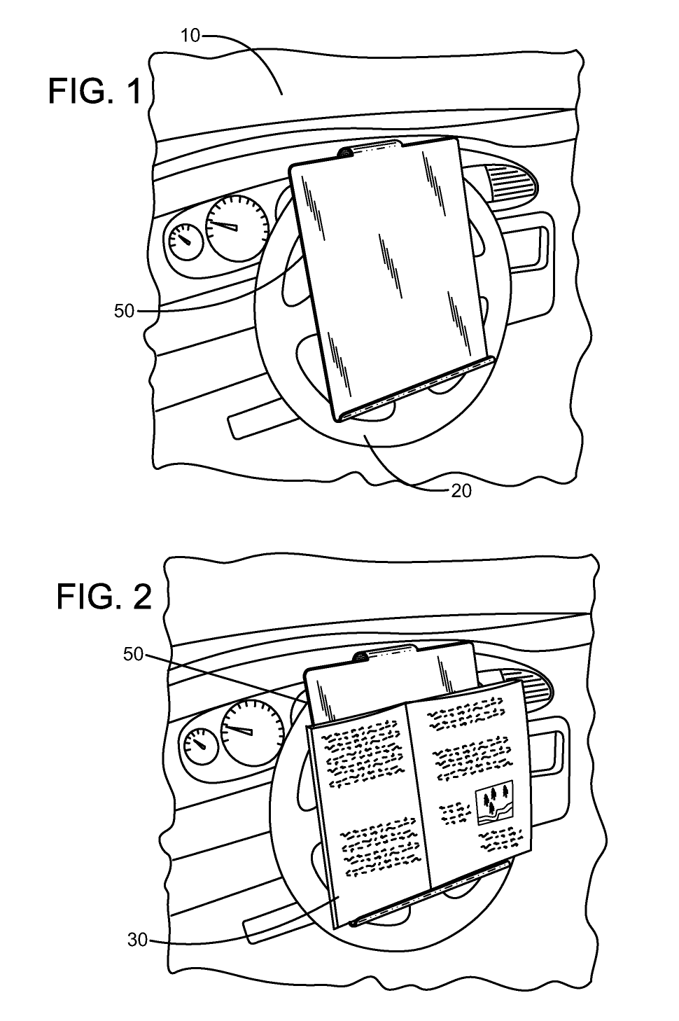

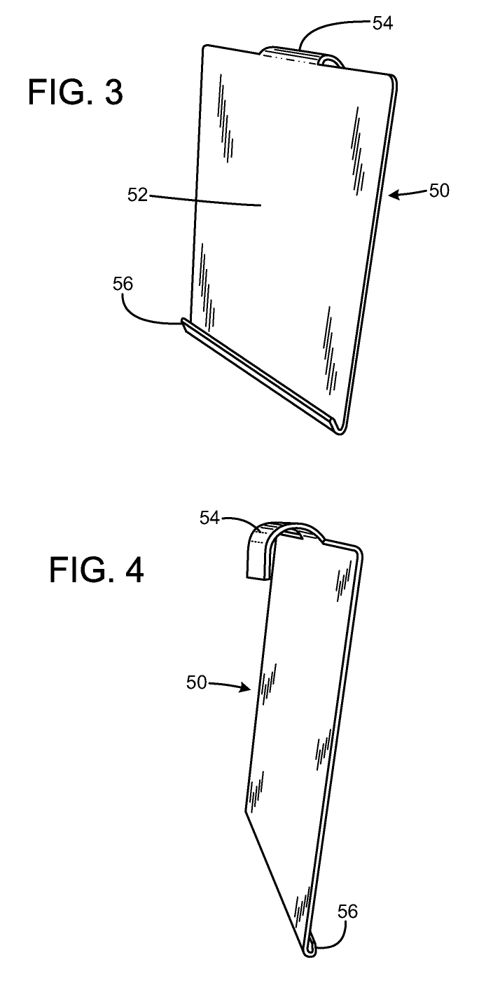

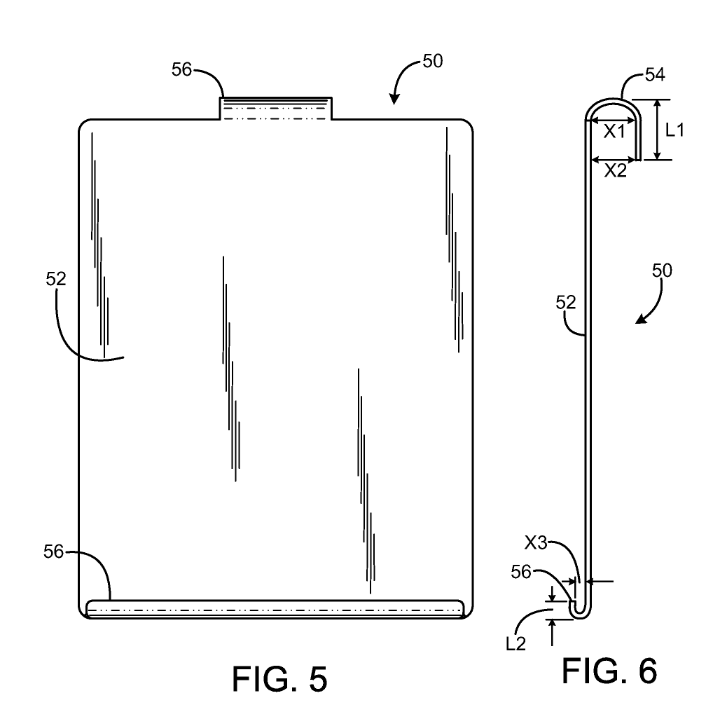

An exemplary embodiment of a portable vehicle desk 50 is illustrated in FIGS. 1-6. This exemplary embodiment is adapted for use in a vehicle 10 having a steering wheel 20. The desk 50 may be constructed as a unitary one-piece structure in this exemplary embodiment, defining a generally planar working surface portion 52, and a retainer portion 54 adapted for engaging the steering wheel 20 to hold the desk in a working position on the steering wheel, as illustrated in FIGS. 1 and 2. A work piece supporting portion 56 is provided at the lower edge of the working surface portion 52 to provide a support for work pieces such as books, papers, pens, pencils and the like. The portable desk 50 is adapted for ready engagement with the steering wheel to support the desk in the working position and for ready disengagement from the steering wheel for storage while the vehicle is in operation.

Fabrication of the portable desk 50 as a unitary one-piece structure may reduce costs. In an exemplary embodiment, the desk may be fabricated from a plastic material, ABS, Sintra™ (a moderately expanded closed-cell polyvinyl chloride (PVC) marketed by Alcan Composites, http://www.alcancompositesusa.com), wood or a sheet metal. In one exemplary embodiment, the desk is fabricated from a sheet of ⅛ inch thick ABS or 3 mm Sintra™, in which a bottom edge is rolled to form the lower work piece supporting portion 56, and the retainer portion is formed during a fabrication process. The retainer portion 54 may be fabricated by cutting or stamping the sheet to form a tab at the end of the working surface opposite the portion 56, and then rolling or forming the tab to form a hook-like retainer portion 54. For example, a sheet of Sintra™ may be used, and formed using a heat process with subsequent cooling to form the sheet to the desired shape.

In other embodiments, the retainer portion and/or supporting portion may be fabricated of separate elements from the working surface portion, which are then assembled together, e.g. by welding, adhesive, fastener or the like.

In an exemplary embodiment, the desk working portion 52 may be 9 5/8 inches wide and 12 1/2 inches long. The retainer portion may have exemplary dimensions as follows, referring to dimensions shown in FIG. 6: L1=1.5 inches; X1=X2=1⅜ inch; X3= 3/16 inch; L2=¼ inch. The desk in an exemplary embodiment may be fabricated of ⅛ inch thick ABS. These dimensions are exemplary, and may be varied according to the requirements of a particular application. For example, a larger desk may be employed for a vehicle having a larger diameter steering wheel, e.g. a van truck, a cross-country 18 wheel big rig, or the like.

To install the desk temporarily on the vehicle wheel while the vehicle is stationary, the desk is placed with the retainer portion 54 adjacent the top edge of the steering wheel, and lowered so that the hook-like retainer portion engages the top rim of the steering wheel. The desk is now in position for use. After the user has finished, the desk is removed from the steering wheel by lifting the desk in a direction away from the steering wheel, for storage or in preparation for vehicle operation.

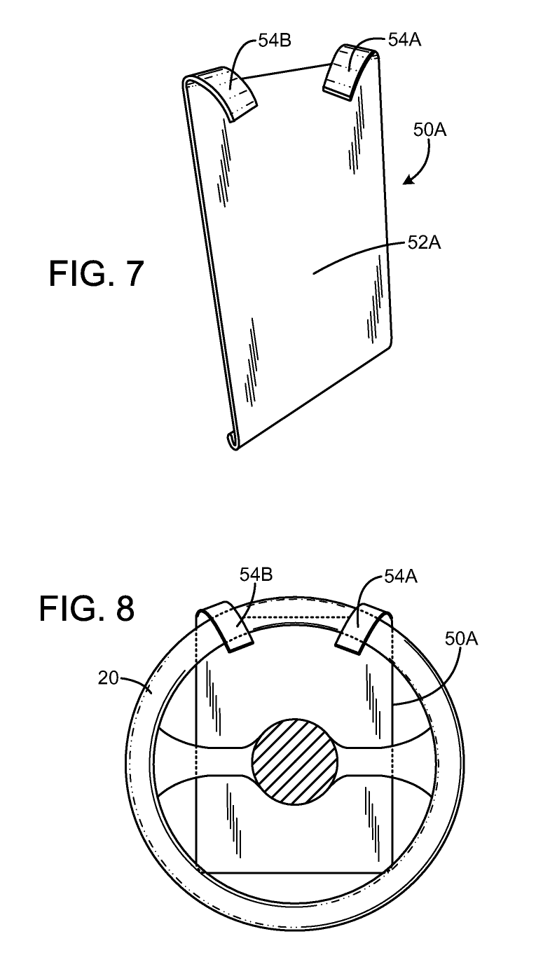

An alternate embodiment of a portable vehicle desk 50A is illustrated in FIGS. 7-8. This embodiment is similar to desk 50 of FIGS. 1-6, except that the retainer portion includes separated retainer portions 54A, 54B. These may be disposed at corners of the working surface portion, for example. The separated retainer portions may provide improved balance and stability of the desk when supported on the steering wheel, reducing a tendency to rock about the retainer portion. The retainer portions 54A, 54B may also be angled so that the inner surfaces of the retainer portions more closely conform to the peripheral surface of the steering wheel when the desk is in the working position. Thus, the retainer portion may include a first hook portion 54A and a second hook portion 54B disposed adjacent upper left and right corners of the working surface portion for engaging respective opposed portions of the steering wheel. The first and second hook portions may be disposed at an angular offset from the vertical to secure the desk in the working position.

Although the foregoing has been a description and illustration of specific embodiments of the invention, various modifications and changes thereto can be made by persons skilled in the art without departing from the scope and spirit of the invention as defined by the following claims.

What is claimed is:

1. A portable desk for use in a vehicle having a steering wheel, the desk comprising:
a unitary one-piece structure defining a generally planar working surface portion, and a retainer portion adapted for engaging the steering wheel to hold the desk in a working position on the steering wheel;
the portable desk being adapted for ready engagement with the steering wheel to support the desk in the working position and ready disengagement from the steering wheel for storage during vehicle operation.

2. The desk of claim 1, wherein the retainer portion includes a retainer hook portion.

3. The desk of claim 2, wherein the hook portion is defined in a center top portion of the desk for engaging a top portion of the rim of the steering wheel.

4. The desk of claim 1, wherein the retainer portion includes a first hook portion and a second hook portion disposed adjacent upper left and right corners of the working surface portion for engaging respective spaced portions of the steering wheel.

5. The desk of claim 4, wherein the first and second hook portions are disposed at an angular offset from the vertical to secure the desk in the working position.

6. The desk of claim 1, wherein the one-piece unitary structure further comprises a work piece retaining portion disposed at a lower desk edge.

7. The desk of claim 6, wherein the work piece retaining portion comprises a formed lip at the lower desk edge.

8. The desk of claim 1, wherein the one-piece unitary structure is fabricated from a plastic material.

9. A portable desk for use in a vehicle having a steering wheel, the desk comprising:
a generally planar working surface portion;
a retainer portion disposed adjacent a top edge of the working surface portion and protruding from a back surface of the working surface portion to form with the back surface a hook-like configuration adapted for engaging the steering wheel to hold the working surface portion in a working position on the steering wheel;
a work piece supporting portion disposed along a lower edge of the working surface portion;
the portable desk being adapted for ready engagement with the steering wheel to support the desk in the working position and ready disengagement from the steering wheel for storage during vehicle operation.

10. The desk of claim 9, wherein the retainer portion is defined in a center top portion of the desk for engaging a top portion of the rim of the steering wheel.

11. The desk of claim 9, wherein the retainer portion includes a first hook like portion and a second hook-like portion disposed adjacent upper left and right corners of the working surface portion for engaging respective spaced portions of the steering wheel.

12. The desk of claim 11, wherein the first and second hook-like portions are disposed so that the inner surfaces of the hook-like portions generally conform to the peripheral surface of the steering wheel when the desk is in the working position.

13. The desk of claim 9, wherein the working surface portion, the retainer portion and the work piece supporting portion are fabricated as a unitary one-piece structure.

14. The desk of claim 13, wherein the unitary, one-piece structure is fabricated from one of the group consisting of a plastic material, ABS, polyvinyl chloride, wood and sheet metal.

15. The desk of claim 13, wherein the unitary, one-piece structure is fabricated from an expanded closed-cell polyvinyl chloride (PVC) material.

16. A portable desk for use in a vehicle having a steering wheel, the desk comprising:
a one-piece structure defining a generally planar working surface portion, a retainer portion protruding from a back surface of the working surface portion and adapted for engaging the steering wheel to hold the working surface portion in a working position on the steering wheel, and a work piece supporting portion disposed along a lower edge of the working surface portion;
the portable desk being adapted for ready engagement with the steering wheel to support the desk in the working position and ready disengagement from the steering wheel for storage during vehicle operation.

17. The desk of claim 16, wherein the retainer portion is defined in a center top portion of the desk for engaging a top portion of the rim of the steering wheel.

18. The desk of claim 16, wherein the retainer portion includes a first hook like portion and a second hook-like portion disposed adjacent upper left and right corners of the working surface portion for engaging respective spaced portions of the steering wheel.

19. The desk of claim 18, wherein the first and second hook-like portions are disposed so that the inner surfaces of the hook-like portions generally conform to the peripheral surface of the steering wheel when the desk is in the working position.

20. The desk of claim 16, wherein the one-piece structure is fabricated from one of the group consisting of a plastic material, ABS, polyvinyl chloride, wood and sheet metal.
